(19) United States
(12) Patent Application Publication
(10) Pub. No.: US 2008/0303297 A1
(43) Pub. Date: Dec. 11, 2008

(54) Corn clamp

(76) Inventors: Joseph Franklin Robert Micallef, Elk Grove, CA (US); Sarah Mae Micallef, Elk Grove, CA (US)

Correspondence Address: Joseph Micallef, 9420 Rainbow Falls way, Elk Grove, CA, 95624, US

(21) Appl. No.: 12/069,393

(22) Filed: Mar. 11, 2008

Related U.S. Application Data
(60) Provisional application No. 60/933,153, filed on Jun. 5, 2007.

(51) Int. Cl. A47J 43/28; A47G 21/00

(52) U.S. Cl. 294/5

(57) ABSTRACT

The corn clamp includes a single solid piece of material which is hinged at or on the handle. The grasping end of the corn clamp contains at least one appendage extending inward toward the cob for easy penetration and grasping of the cob and is designed to keep the cob securely and in a non-rotatable position in the corn clamp.

### BACKGROUND OF THE INVENTION

Current corn holders consist of an elongated piece of metal or plastic containing one or more nail type piece(s) used to pierce the ends of corn for easy holding and eating of corn on the cob.

### FIELD OF THE INVENTION

The present invention relates to eating utensils, and more specifically, to eating utensils used for grasping onto corn on the cob.

### DESCRIPTION OF THE RELATED ART

A majority of people have enjoyed corn on the cob. While eating corn on the cob there have been two ways to hold and eat the corn while on the cob. First, is simply by using your bare hands, which often times burns the individual's fingers and/or is extremely messy. The second method is to use a type of “corn holder” which pierces each end of the cob with a device which contains at least one “nail” type object.

This nail type object is dangerous in the fact that it may slip while piercing each end of the cob and the user may jab the metal nail type object into their other hand or arm.

In addition to the danger aspect of current corn holders, they also become loose within/from the cob very easily and often times will fall out of the cob, sometimes causing the user to drop their corn on the floor or lap.

This invention eliminates the potential for injury, loosing your corn and a big mess. Thus a corn clamp solving the aforementioned problems is desired.

### SUMMARY OF THE INVENTION

The present invention includes a multi sided flexible piece with each side containing at least one “spike or tooth like” appendage which pierces into the cob.

The objective of this invention is to provide an improved utensil used for grasping onto and eating corn on the cob.

These and other features of the present invention will become readily apparent upon further review of the following specifications and drawings.

### BRIEF DESCRIPTION OF THE DRAWINGS

FIG. 1 is an environmental side view of the corn clamp according to the present invention.

FIG. 2 is an environmental view of the front end of the corn clamp according to the present invention.

FIG. 3 is an environmental side view of the corn clamp in use according to the present invention.

### DETAILED DESCRIPTION OF THE PREFERRED EMBODIMENTS

The present invention is a corn clamp, designed generally as 10 in the drawings.

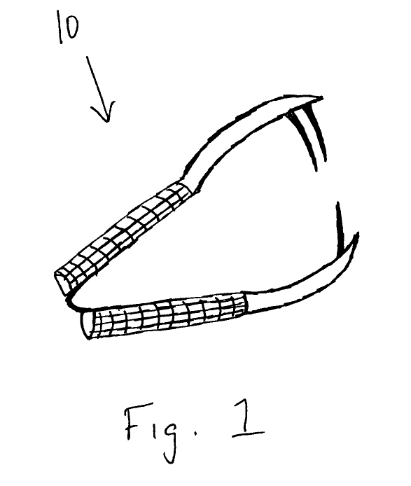

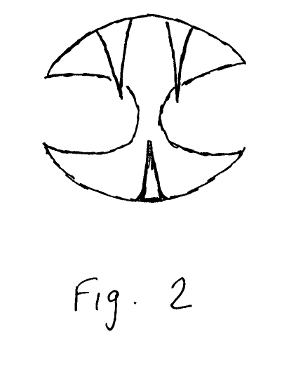

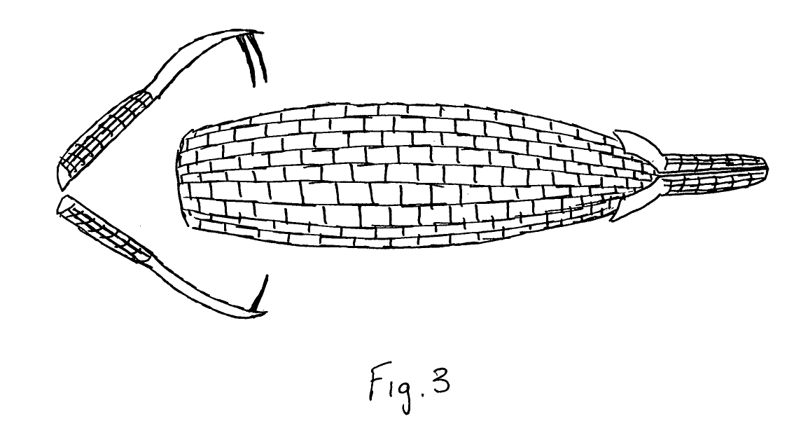

Referring to the FIGS. 1-3 of the drawings, the corn clamp 10 is designed to bite into and grasp onto each end of the corn cob. In a preferred embodiment, the corn clamp 10 is contoured to the shape of the cob and will easily grasp or bite into each end of the cob.

The corn clamp 10 is made of a rigid material which will stand the test of time as well as provide for safe handling and cleaning.

It is to be understood that the present invention is not limited to the embodiments described above, but encompasses any and all embodiments within the scope of the following claims.

We claim:

1. A corn clamp, comprising of a solid piece of rigid and durable material forming a handle which contains a flexible hinge type device with spike or tooth like appendage(s) for securely grasping and clamping the cob in a non-rotatable position.

2. The corn clamp of claim 1 which comprises of a rigid molded material.

3. The corn clamp of claim 1 where the spike or tooth like appendages are pointed or serrated or knife like for easy penetration into the cob.

4. The corn clamp of claim 1 which contains a flexible hinged like device to keep each portion of the corn clamp together and allows the device to open and close appropriately.

5. The corn clamp of claim 1 wherein contains the spike or tooth like appendages which are positioned in a way which extends inward toward the cob.

6. The corn clamp of claim 1 wherein said device, including the handle, appendage(s) and hinge are formed of an integral single piece of material.

7. A handle means an end of the corn clamp which is adapted for the user to grasp onto.
